(19) United States
(12) Patent Application Publication
(10) Pub. No.: US 2009/0036588 A1
(43) Pub. Date: Feb. 5, 2009

(54) Silicone wire and cable insulations and jackets with improved abrasion resistance

(76) Inventors: Mark R. Easter, Indianapolis, IN (US); Gregg Szylakowski, Bargersville, IN (US)

Correspondence Address: BLANK ROME LLP, 600 NEW HAMPSHIRE AVENUE, N.W., WASHINGTON, DC, 20037, US

(21) Appl. No.: 11/655,144

(22) Filed: Jan. 19, 2007

Related U.S. Application Data
(60) Provisional application No. 60/760,385, filed on Jan. 20, 2006.

(51) Int. Cl. C01B 33/26; C08L 83/04; C08K 3/36; C01B 33/24

(52) U.S. Cl. 524/444; 524/588; 524/493; 524/456; 264/176.1

(57) ABSTRACT

Improved silicone rubber compositions, including silicone wire and cable insulations and jackets are disclosed. Silica fillers of specified surface area in specified amounts give silicone wire and cable insulations and jackets with improved abrasion resistance. These insulations and jackets are useful in wires and cables that require heat resistance, fire resistance and low temperature flexibility. Low cost formulations that can find use in new applications are disclosed.

The present application claims priority under 35 U.S.C. §119 to U.S. Provisional Application, Ser. No. 60/760,385, filed Jan. 20, 2006.

### FIELD OF THE INVENTION

Improved silicone rubber compositions are disclosed as useful for, among other things, silicone wire and cable insulations and jackets, hoses, tubing, bumpers, bushings, and other automotive and industrial applications. Silica fillers of specified surface area in specified amounts are used to give silicone wire and cable insulations and jackets with improved abrasion resistance. These insulations and jackets are useful, for example, in wires and cables that require heat resistance, fire resistance and low temperature flexibility. Low cost formulations that can find use in new applications are also disclosed.

### BACKGROUND OF THE INVENTION

Silicone rubber insulation or jacketing is used where high heat resistance or fire resistance is needed, for example, in circuits that must withstand fire to control critical equipment in buildings, emergency lighting, control circuits in mass transit systems, military shipboard cables, and high temperature heating cables. Silicone rubber is used on most gasoline engine ignition wire. It is used in cable designs that meet the requirements of IEC331 and IEC245 harmonized standard for flexible cords type EI2.

Silicone has a self ignition temperature of 550 degrees C., higher than any other insulation material except polytetrafluoroethylene (PTFE) at 590 degrees C., and far exceeds the self ignition temperature of polyethylene at 350 degrees C. Silicone rubber has the lowest amount of heat released from combustion of any insulating polymer. Flame can propagate undesirably along cables that run between different parts of a building. PTFE releases toxic and corrosive halogen containing gasses in a fire and is not flexible. Silicone rubber does not give off toxic gas when burned; it is primarily an inorganic based material that degrades to form primarily inert silicon dioxide.

Polyolefins containing high levels of fillers such as aluminum trihydrate and magnesium hydroxide are somewhat flame retardant and reduce levels of toxic smoke, but are not flexible and can have poor electrical properties.

Silicone rubber insulation is also used in cables that must be flexible at very low temperatures as low as −80 degrees C. lower than rubber that is not flexible below 50 degrees C. and polyethylene which is not flexible below 20 degrees C.

Silicone rubber also has the advantage that it may be cured in hot air unlike most polyolefins, and may easily be cured with moisture as hydrolysable silane groups can be polymerized on the silicone polymer backbone.

The disadvantages of using silicone based rubbers as an insulation material are low physical properties, tear strength and low abrasion resistance. Hoses and tubing, bumpers, bushings and other automotive and industrial and consumer goods are subject to abrasion which can cause poor appearance and/or wear and poor performance. In addition, most cables are subject to abrasion either during installation or in service or both. Cables are pulled into ducts, along tracks and through rough openings. Flexible cords are dragged along the ground or other rough surfaces. Ignition wires are abraded by contact with under hood components and engine vibration. Fluoro silicones and so called tough rubbers offer some improvement but cost four or more times as much as common diethyl methylvinylsiloxane. Because of the low abrasion resistance of silicone rubber its use has been limited to critical cables that must have fire or temperature resistance. These cables have to be carefully handled and installed to limit abrasion, or frequently replaced if they must be subjected to abrasion. Therefore there has been a long felt need for cable insulation with the properties of silicone and higher abrasion resistance at a low cost.

Abrasion resistant coatings for silicone rubber are disclosed in U.S. Pat. No. 6,596,401, and U.S. Published Patent Applications 2006/0000633 and 2006/0004170, which are incorporated herein by reference. These coatings are, however, difficult to prepare, require primer and/or graft initiators and/or other surface preparation to facilitate adhesion of the coating to the substrate, may contain volatile organic compounds, require drying time and are costly. The coatings are thin and usually work by reducing the coefficient of friction. While they provide a small level of protection of the substrate they quickly wear off leaving the substrate vulnerable to abrasion. Addition of silicone oils which migrate to the surface are known to lower coefficient of friction but do not improve abrasion resistance.

It is known to add 10 to 30 phr (parts per hundred parts rubber, by weight) PTFE or high molecular weight TFE/HFP fluoroplastic micropowder to olefin polymers to lower the coefficient of friction and improve wear resistance.

As shown in the Comparative Examples in this disclosure, and regarding compositions that have heretofore been unknown in the art and were investigated during the discovery of this invention, fluoropolymer additives do improve the abrasion resistance of silicone rubbers somewhat but can easily double the cost of the resulting silicone rubber composition. Also, as the level of fluoropolymer additive increases to give acceptable abrasion resistance, the additive can adversely affect the rheology of the compound as shown by high Mooney viscosity.

It is known that some silicone base rubbers with no fillers have good abrasion resistance but they are difficult or impossible to extrude into products because they are soft and have low green strength. They also have low tear strength. They are typically provided in 5 to 20 pound blocks that can not be fed into an extruder. Usually it is desired to add color concentrates which can not be done to a block. Their durometer hardness is also too low to resist deformation from crushing of the cable or from crimping on terminations.

It is known to add fumed silica to silicone rubber to improve its tensile and tear strength. Fumed silica is extremely expensive and costs up to ten times as much as common microcrystalline silica. Treated grades are necessary to prevent so called crepe hardening or structuring which makes the silicone compound unprocessable after about a week. Silane treated fumed silica is known to be more reinforcing but it can cost up to twenty times as much as common microcrystalline silica. It is also more difficult to incorporate into silicone base rubber due to its fluffy nature.

U.S. Pat. No. 6,020,402, incorporated herein by reference, provides a further description of fillers used in silicone rubber.

It is known that applying a braid of fiberglass or other yams to the insulation of an ignition wire and then extruding a silicone jacket over the braid slightly improves abrasion resistance by preventing the jacket from moving or bunching up in front of the abrading surface. U.S. Pat No. 4,704,596, incorporated herein by reference, discloses an abrasion resistant ignition wire with a fiberglass braid, an adhesive and EPDM jacket and the method of making such a cable.

To fill the need for the complete lack thereof, the invention provides an abrasion resistant silicone rubber compound for wire and cable insulation or jacketing that is low in cost and easy to produce.

### SUMMARY OF THE INVENTION

An abrasion resistant silicone rubber composition is provided comprising a silicone base rubber, and an additive selected from the group consisting of precipitated silica, a blend of precipitated silica and fumed silica, a blend of microcrystalline silica and fumed silica and a blend of precipitated silica and microcrystalline silica. An abrasion resistant extruded article made from the composition of the invention is also provided.

In embodiments of the invention, the precipitated silica has a surface area from about 30 m²g to about 250 m²g, preferably from about 50 m²g to about 200 m²g, more preferably from about 110 m²g to about 170 m²g.

In further embodiments of the invention the additive is present in an amount of from about 15 phr to about 60 phr. When the additive is comprised only of precipitated silica, it may be present in the amount of from about 5 phr to about 35 phr.

### DETAILED DESCRIPTION OF THE INVENTION

The inventors have discovered the unexpected result that the addition of (a) precipitated silica, or (b) a blend of precipitated and fumed silica, (c) a blend of fumed and microcrystalline silica or (d) a blend of precipitated silica and microcrystalline silica to silicone base rubber can dramatically improve the abrasion resistance of the resulting composition. In particular, about 5 to 60 phr of silica additive (a), (b), (c) or (d) can greatly increase abrasion resistance. Additive (a) precipitated silica may be especially effective in amounts of from about 5 phr to about 35 phr. Precipitated calcium silicate and aluminum silicate may be used in addition to the silica additive (a), (b), (c) or (d) in the composition of the invention.

The silicone base rubber in accordance with the invention may be any of the multitude of available silicone rubber materials available in the art. As is known to those skilled in the art, depending on the desired properties and end use application, a variety of silicone polymers can be produced, and certain chemical and physical properties can be enhanced, by replacing a portion of the methyl-containing groups in the polydimethyl siloxane chain with phenyl-containing groups, vinyl-containing groups, fluorine-containing groups, phenyl- and vinyl-containing groups, and mixtures thereof. For example, dimethyl silicone rubber tends to become stiff below −60 degrees F. It has been found that the low temperature flexibility may be improved by substitution of only five percent of the methyl groups with phenyl groups in the polymer chain. This substitution lowers the crystallization temperature, allowing use of the silicone rubber to temperatures below −130 degrees F. It has also been found that less than 0.5 percent of a vinyl-containing group, such as methylvinyldichloro silane, results in a low compression set silicone polymer that requires less peroxide curing agent to cure. Finally, it has been found that the replacement of one methyl group on each silicon atom in the polymer chain with a polar group, such as trifluoropropyl, reduces swelling in aliphatic and aromatic hydrocarbons. application.

Precipitated silica additives with BET surface area of 30 m²g to 250 m²g are useful in the invention. Below 30 m²g less abrasion resistance is achieved. Above 250 m²g the Mooney viscosity becomes too high and the silica is too difficult to disperse. Price also increases rapidly with surface area. The preferred range is 50 m²g to 200 m²g. The most preferred range is 110 m²g to 170 m²g. For the use of fumed silica, BET surface areas of 50 m²g to 300 m²g are useful in the invention, and the preferred range is 100 m²g to 250 m²g. Because microcrystalline silica is ground silica with mostly flat surfaces and without the complex shapes and porosity of fumed and/or precipitated silica, the surface area of the microcrystalline silica is not considered important to obtaining the results in accordance with the silicone rubber composition of the invention.

Surprisingly, addition of the preferred precipitated silica can actually lower the cost of the silicone compound compared to the base rubber. Precipitated silica costs only 50% more than microcrystalline silica. Some microcrystalline silica can be blended into the invention to lower cost and improve properties. As little as 10 parts of precipitated silica blended with 50 parts of microcrystalline silica gives an unexpectedly good abrasion result as shown in the Examples in accordance with the invention. Blends of silicas can also give desirably higher tear strength and lower Mooney viscosities while having acceptable abrasion resistance. Die C tear strength of over 100 is very desirable for a cable insulation or jacket so that it does not tear if pulled over a rough object or opening.

The silica additives of the invention and of the various comparative examples were mixed into silicone base rubber at various levels in a Banbury mixer. The following mix procedure was used: one half of the silica additive was added, followed by the silicone base rubber and any color additive, followed by the remaining half of the silica additive with the silane completing the addition of ingredients. When the batch mix temperature reached 150° F. the rain was raised and the throat was swept. When the batch mix temperature reached 180° F. the lower door was opened and the batch was dropped.

Comparative Examples A through T show certain compositions currently available, as well as the limits of the invention, e.g., high filler levels that could not be mixed, compositions that have processing problems for other reasons or have undesirable final properties, or in certain instances compositions that are so costly they are undesirable for that reason alone even though their properties are acceptable and they may be capable of being processed. Comparative Example A is a commercial General Cable ignition wire jacket compound. Comparative Examples D, E, F, I, and J did show fairly good abrasion but their viscosity is too high to be mixed or extruded in a thermoset silicone and shear heating would result in premature cure. Also, as mentioned above, the cost is much more than the silicone rubber compositions in accordance with the invention as either the fluoropolymer additive or the very large amount of “tough rubber” silicone base polymer used to increase the abrasion resistance adds excessive cost. It is considered that certain amounts of toughened silicone rubber base polymer may be used in accordance with the invention, however, this is in contrast to Comparative Examples I and J wherein it is used in large quantities with only a microcrystalline silica additive. Comparative Examples I and J had fairly good abrasion resistance but their cost is many times the formulations of the invention and their die C tear strength is below 100.

Examples 1-7 in accordance with the invention show the greatly improved abrasion resistance of the invention. Example 2 shows very high abrasion resistance at the lowest cost. Surprisingly precipitated silica additive Sipernat 120 has a lower surface area and should presumably be less reinforcing but has better abrasion resistance than precipitated silica additive Sipernat 160. Examples with more silica additive show desirably higher durometer hardness. Quite surprisingly blends of fumed and precipitated silicas with microcrystalline silica show lower viscosity and lower cost while having fairly good abrasion resistance and may be desirable for some applications.

In the following Examples 8-15, the precipitated silica level was varied from 5 to 33 phr with all other aspects of the composition in accordance with the invention being the same as in Example 2 with the use of silicone base rubber from either GE or Wacker as noted in Table I. The abrasion resistance decreased somewhat as the filler was varied from 5 to 17 phr and then increased when varied from 17 to 33 phr. All Abrasion results were extremely desirable values for a silicone rubber material. A level somewhat higher than 33 phr resulted in a hard coal like compound dropping out of the Banbury. This trend was noticed with various silicone base rubbers from multiple suppliers.

TABLE I

| | phr Sipernat | Abrasion | | Durometer |
|---|---|---|---|---|
| EXAMPLE | 120 | ASTM D1630 | Tear “Type C” | hardness |
| 8 | 5 w/Wacker | 7481 | 99 | |
| 9 | 5 w/GE | 10195 | 96 | 70 |
| 10 | 11 w/Wacker | 5804 | 110 | |
| 11 | 11 w/GE | 6357 | 96 | 77 |
| 12 | 17 w/Wacker | 4439 | 110 | |
| 13 | 17 w/GE | 3886 | 98 | 84 |
| 14 | 22 w/Wacker | 3414 | 102 | 100 |
| 2 | 22 w/GE | 5144 | 100 | |
| | (Example 2) | | | |
| 15 | 33 w/Wacker | 3794 | 99 | |

### Comparative Example U

Prior to the invention of applicants, it was perceived that silicone rubber could never be as abrasion resistant as EPDM. A commercial abrasion resistant EPDM rubber cable insulation used in abrasion resistant cords was tested, General Cable E14728A. Its abrasion resistance was 3480. As shown above, many compositions in accordance with the invention exceed this value.

### Comparative Example Using Competitor's Coated Ignition Wire

An ignition wire was extruded with the compound of the invention, Example 4, and Comparative Example A. A thin plastic tape was used to separate the jacket from the insulation as described in U.S. Pat. No. 4,677,418. In particular, a conductive fiber glass core was passed through a crosshead die and a layer of EPDM insulation was extruded over it and passed through a steam pressurized catenary tube to cure it. The core and insulation were then passed through a second crosshead die and the silicon jacket extruded over it and passed through a steam pressurized catenary tube to cure it.

The results were compared to a competitor's ignition wire sold as an abrasion resistant ignition wire and advertised as having an abrasion resistant coating over silicone rubber jacketing. Wires were tested on a reciprocating abrasion tester (as compared to all other abrasion testing in this application which was done in accordance with ASTM D1630, which does not work for wire samples) wherein a 181 gram weight and 40 grit sandpaper were used to test time (# cycles) to complete abrasion for equal thickness silicone rubber layers. Any layer not exactly equal in thickness to its comparison was normalized for comparison.

TABLE II

| | Cycles |
|---|---|
| Competitor's coated wire | 18,827 |
| 7 mm | |
| Competitor's coated wire - | 24,656 |
| 8 mm | |
| Example 2 - | 43,567 |
| 7 mm | |
| Example 2 - | 51,125 |
| 8 mm | |
| Example A - | 5,263 |
| 7 mm | |
| Example A - | 4,357 |
| 8 mm | |
| Example 12 | 94,446 |
| 7 mm | |
| Example 12 | 97,946 |
| 8 mm | |

### Ingredients

Imsil A10, microcrystalline silica, Unimin Specialties Minerals, surface area 6.1 m²g
Sipernat 160, precipitated silica, Degussa, surface area 165 m²g
Sipernat 120, precipitated silica, Degussa, surface area 125 m²g
Aerosil 972, fumed silica, silane treated, Degussa, surface area 170 m²g
Cab-O-Sil, LM150, fumed silica, Cabot Corp., untreated, surface area 160 m²g.
MP 1500, fluoropolymer additive
   Examples 1-7 and Comparative Examples A-T are shown with their associated testing data and results in the following three pages. All components are shown as phr, i.e., parts per hundred parts rubber, by weight.

TABLE III

| | FORMULATION | | | | | | |
|---|---|---|---|---|---|---|---|
| | 1 | 2 | 3 | 4 | 5 | 6 | 7 |
| Wacker 510/55 silicone base | | | 100 | 100 | 100 | 100 | 100 |
| GE SE 6250 silicone base | 100 | 100 | | | | | |
| Imsil A10 microcrystalline silica | | | 22 | 22 | 22 | 22 | 50 |
| Cab-o-sil LM150 | | | | 22 | | | |
| Aerosil 972V | | | | | 22 | | |
| Sipernat 120 | | 22 | | | | 22 | 10 |
| Sipernat 160 | 22 | | 22 | | | | |
| GE A174 NT vinyl saline | 0.36 | 0.36 | 0.36 | 0.36 | 0.36 | 0.36 | 0.36 |
| Geo Vulcup 40 SI | 1.20 | 1.20 | 1.20 | 1.20 | 1.20 | 1.20 | 1.20 |
| K21122 Black Paste color | 4.36 | 4.36 | 4.36 | 4.36 | 4.36 | 4.36 | 4.36 |
| TOTAL | 127.92 | 127.92 | 149.92 | 149.92 | 149.92 | 149.92 | 165.92 |

MOONEY @ 82.2° C.

| | | | | | | | |
|---|---|---|---|---|---|---|---|
| I.R. | 221.60 | 181.11 | 105.07 | 107.95 | 123.91 | 83.87 | 103.32 |
| MV(1 + 4) | 139.28 | 88.01 | 79.18 | 70.65 | 94.69 | 59.72 | 65.89 |
| VISCOSITY @ MIN | 133.64 | 85.21 | 78.17 | 69.96 | 93.68 | 58.99 | 64.81 |

AIR AGED 70 hr 400° F. (204° C.)

| | | | | | | | |
|---|---|---|---|---|---|---|---|
| TENSILE | 811 | 815 | 904 | 896 | 827 | 775 | 897 |
| STANDARD DEVIATION | 94 | 43 | 17 | 49 | 69 | 20 | 80 |
| % ELONGATION | 156 | 160 | 223 | 191 | 160 | 208 | 299 |
| STANDARD DEVIATION | 19 | 9 | 5 | 15 | 14 | 4 | 29 |
| % TENS RETAINED | 67 | 79 | 83 | 87 | 74 | 75 | 80 |
| % ELONG RETAINED | 50 | 65 | 63 | 62 | 56 | 67 | 70 |
| TEAR (Lbs/in) | 11.45 | 6.56 | 13.66 | 11.83 | 10.78 | 11.93 | 16.19 |
| STANDARD DEVIATION | 1.13 | 0.39 | 0.33 | 0.43 | 0.3 | 0.75 | 1.66 |
| TEAR “C”(Lbs/in) | 113.05 | 100.32 | 117.48 | 117.91 | 113.59 | 109.65 | 115.09 |
| STANDARD DEVIATION | 4.59 | 3.41 | 4.75 | 3 | 2.77 | 3.34 | 1.67 |
| SPECIFIC GRAVITY | 1.264 | 1.2647 | 1.3853 | 1.3905 | 1.3836 | 1.3842 | 1.2808 |

Durometer Hardness

| | | | | | | | |
|---|---|---|---|---|---|---|---|
| ABRASION | 3021 | 5144 | 3174 | 1767 | 2633 | 2627 | 3047 |

TABLE IV

| | FORMULATION | | | | | | | | | |
|---|---|---|---|---|---|---|---|---|---|---|
| | A | B | C | D | E | F | G | H | I | J |
| GE 6250 | 100 | 100 | 100 | 100 | 100 | 100 | | | | |
| Wacker ELR 510/55 | | | | | | | 100 | | | |
| Wacker 401/70 | | | | | | | | 100 | | |
| Dow “Tough Rubber” | | | | | | | | | 100 | |
| 55 Silicone | | | | | | | | | | |
| Dow TR 70 Silicone | | | | | | | | | | 100 |
| Imsil A10 | 100 | 100 | 100 | 100 | 100 | 100 | 100 | 100 | 100 | 100 |
| A174 NT | 0.36 | 0.36 | 0.36 | 0.36 | 0.36 | 0.36 | 0.36 | 0.36 | 0.36 | 0.36 |
| Vulcup 40 SI | 1.07 | 1.45 | 1.45 | 1.45 | 1.45 | 1.45 | 1.45 | 1.45 | 1.45 | 1.45 |
| MP1500 | | | | 10 | 20 | 30 | | | | |
| Dow Corning 550R | | 0.5 | | | | | | | | |
| Silicon oil | | | | | | | | | | |
| Silquest 597 | | | 0.18 | | | | | | | |
| TOTAL | 201.43 | 202.31 | 202.00 | 211.82 | 221.82 | 231.82 | 201.82 | 201.82 | 201.82 | 201.82 |

MOONEY @ 82° C.

| I.R. | 76.26 | 69.8 | 70.46 | 143.23 | | | 39.46 | 47.98 | 56.73 | 50.71 |
|---|---|---|---|---|---|---|---|---|---|---|
| VISCOSITY | 36.63 | 36 | 37.73 | 78.66 | >250 | >250 | 31.11 | 30.53 | 30.05 | 29.48 |
| INITIAL | Cured 20 min. @ 350° F. | | | | | | | | | |
| TENSILE (PSI) | 858 | 941 | 1023 | 940 | 866 | 1117 | 1005 | 997 | 959 | 970 |
| STANDARD DEVIATION | 14 | 14 | 61 | 44 | 52 | 18 | 43 | 47 | 27 | 71 |
| % ELONGATION | 185 | 190 | 177 | 182 | 196 | 226 | 209 | 144 | 194 | 118 |
| STANDARD DEVIATION | 8 | 8 | 16 | 19 | 32 | 17 | 15 | 9 | 9 | 13 |
| TEAR (Lbs/in) | 5.64 | 5.76 | 5.42 | 10.74 | 30.79 | 40.45 | 5.81 | 6.22 | 7.64 | 5.82 |
| STANDARD DEVIATION | 0.26 | 0.3 | 0.24 | 0.25 | 5.86 | 2.46 | 0.16 | 0.21 | 0.24 | 0.4 |
| TEAR “C” (Lbs/in) | 76.27 | 73.95 | 75.13 | 109.47 | 177.99 | 278.02 | 77.99 | 94.42 | 94.32 | 99.57 |
| STANDARD DEVIATION | 1.35 | 1.26 | 2.27 | 2.17 | 5.76 | 11.99 | 1.98 | 2.33 | 3.62 | 3.42 |
| SPECIFIC GRAVITY | 1.6037 | 1.6091 | 1.5836 | 1.6313 | 1.6553 | 1.6699 | 1.6243 | 1.6344 | 1.6081 | 1.634 |
| Durometer Hardness | | 77.4 | 78 | 79 | 88.4 | 91.8 | | 77.8 | 87 | 82 |

Abrasion Testing (Benz)

| | | | | | | | | | | |
|---|---|---|---|---|---|---|---|---|---|---|
| Revolutions based on | 354 | 329 | 377 | 767 | 1342 | 2763 | 519 | 428 | 1750 | 1831 |
| 45 mil | | | | | | | | | | |

TABLE V

| | FORMULATION | | | | | | | | |
|---|---|---|---|---|---|---|---|---|---|
| | K | L | M | O | P | Q | R | S | Q |
| GE 6250 | 100 | 100 | 100 | 100 | 100 | 100 | 100 | 100 | 100 |
| Imsil A10 | 64 | 64 | 64 | 64 | | | | | |
| Cab-o-sil LM150 | | | | | 64 | | | | 27 |
| Aerosil R972V | | | | | | 64 | 27 | | |
| Sipernat 120 | | | | | | | | 64 | |
| Sipernat 160 | | | | | | | | | |
| A174 NT | 0.36 | | | | 0.36 | 0.36 | 0.36 | 0.36 | 0.36 |
| A1524 | | 0.36 | | | | | | | |
| A151 | | | 0.36 | | | | | | |
| RC4 | | | | 0.36 | | | | | |
| Vulcup 40 SI | 1.45 | 1.45 | 1.45 | 1.45 | 1.45 | 1.45 | 1.45 | 1.45 | 1.45 |
| K21122 Black Paste | 4.36 | 4.36 | 4.36 | 4.36 | 4.36 | 4.36 | 4.36 | 4.36 | 4.36 |
| TOTAL | 169.81 | 169.81 | 169.81 | 169.81 | 169.81 | 169.81 | 133.18 | 169.81 | 133.17 |
| MOONEY @ 82.2° C. | | | | | Could not mix | Could not mix | | Could not mix | |
| I.R. | 52.89 | 56.56 | 60.31. | 55.25 | | | 207.07 | | |
| VISCOSITY | 32.84 | 35.33 | 34.55 | 33.34 | | | 92.46 | | >250 |
| INITIAL | | | | | | | | | |
| TENSILE (PSI) | 996 | 923 | 965 | 906 | | | 1074 | | 1100 |
| % ELONGATION | 226 | 235 | 272 | 287 | | | 182 | | 272 |
| TEAR (Lbs/in) | 6.50 | 7.67 | 8.12 | 9.05 | | | 7.05 | | 7.3 |
| STANDARD DEVIATION | 0.17 | 0.37 | 0.53 | 0.19 | | | 0.26 | | |
| TEAR “C”(Lbs/in) | 83.03 | 87.66 | 86.18 | 87.30 | | | 106.93 | | 116 |
| Durometer Hardness | 90.20 | 77.40 | | | | | | | |
| SPECIFIC GRAVITY | 1.4818 | 1.483 | 1.4826 | 1.482 | | | 1.4466 | | |
| Abrasion | 1220 | 822 | 611 | 519 | | | 1500 | | 3827 |

What is claimed is:

1. An abrasion resistant silicone rubber composition comprising:
(a) a silicone base rubber, and
(b) an additive selected from the group consisting of precipitated silica, a blend of precipitated silica and fumed silica, a blend of microcrystalline silica and fumed silica and a blend of precipitated silica and microcrystalline silica.

2. A composition according to claim 1 wherein said precipitated silica has a surface area from about 30 m²g to about 250 m²g.

3. A composition according to claim 1 wherein said precipitated silica has a surface area from about 50 m²g to about 200 m²g.

4. A composition according to claim 1 wherein said precipitated silica has a surface area from about 10 m²g to about 170 m²g.

5. A composition according to claim 1 wherein said additive is present in an amount of from about 15 phr to about 60 phr.

6. A composition according to claim 1 wherein said additive is present in an amount of from about 20 phr to about 45 phr.

7. A composition according to claim 1 having an abrasion resistance value of 1000 as measured by ASTM D1630.

8. A composition according to claim 1 having an abrasion resistance value of 1500 as measured by ASTM D1630.

9. A composition according to claim 1 wherein said additive is precipitated silica.

10. An abrasion resistant extruded article having a layer made from an abrasion resistant silicone rubber composition, said abrasion resistant silicone rubber composition comprising:
(a) a silicone base rubber, and
(b) an additive selected from the group consisting of precipitated silica, a blend of precipitated silica and fumed silica, a blend of microcrystalline silica and fumed silica and a blend of precipitated silica and microcrystalline silica.

11. An article according to claim 10 wherein said additive further comprises calcium silicate, aluminum silicate or combinations thereof.

12. An article according to claim 10 wherein said precipitated silica has a surface area from about 50 m²g to about 200 m²g.

13. An article according to claim 10 wherein said precipitated silica has a surface area from about 110 m²g to about 170 m²g.

14. An article according to claim 10 wherein said additive is present in said layer in an amount of from about 15 phr to about 60 phr.

15. An article according to claim 10 wherein said additive is present in said layer in an amount of from about 20 phr to about 45 phr.

16. An article according to claim 10 wherein said layer has an abrasion resistance value of 1000 as measured by ASTM D1630.

17. An article according to claim 10 wherein said layer has an abrasion resistance value of 1500 as measured by ASTM D1630.

18. An article according to claim 17 wherein said additive is precipitated silica.

19. An article according to claim 10 wherein said layer is an outermost layer.

20. A method of making an abrasion resistant extruded article comprising forming a layer of the composition according to claim 1.
